(19) United States
(12) Patent Application Publication
(10) Pub. No.: US 2021/0106873 A1
(43) Pub. Date: Apr. 15, 2021

(54) AUDIO SYSTEM FOR BROADCASTING RUNNING AND METHOD FOR BROADCASTING RUNNING USING THE SAME

(71) Applicant: Jong Hwa LEE, Seongnam-si (KR)

(72) Inventor: Jong Hwa LEE, Seongnam-si (KR)

(21) Appl. No.: 16/695,214

(22) Filed: Nov. 26, 2019

(30) Foreign Application Priority Data
Oct. 14, 2019 (KR) 10-2019-0126836

(51) Int. Cl. A63B 24/00; H04H 60/13; H04H 60/73; H04N 21/236; A63B 71/06

(52) U.S. Cl. CPC A63B 24/0062; H04H 60/13; H04H 60/73; A63B 71/0622; A63B 24/0021; A63B 24/0003; H04N 21/23614

(57) ABSTRACT

Provided is an audio system for broadcasting running. The audio system includes: a record management unit configured to manage running records of a specific runner; a runner matching unit configured to recommend candidate matching runners belonging to the other space different from a space of the specific runner and having running records commensurate with the running record of the specific runner; a matching runner information receiving unit for receiving information about a runner selected by the specific runner as a running competitor of the specific runner from among the candidate matching runners recommended by the runner matching unit; and a running broadcasting unit for broadcasting a running situation of the specific runner in real time in comparison with one selected from a past time point and a current time point of the matching runner.

### CROSS-REFERENCE TO RELATED APPLICATIONS

This application claims the priority of the Korean Patent Application NO 10-2019-0126836 filed on Oct. 14, 2019, in the Korean Intellectual Property Office, the disclosure of which is incorporated herein by reference.

### BACKGROUND OF THE INVENTION

### 1. Field of the Invention

The present invention relates to an audio system for broadcasting running and a method for broadcasting running using the same, and more specifically, to an audio system for broadcasting running in consideration of at least one of running records and running environment information of a specific runner and a method for broadcasting running using the same.

### 2. Description of the Prior Art

Recently, various technologies for linking exercise and electronic devices have been developed. By linking the exercise with the electronic device, users can manage their exercise records.

In the case of running, running together may be advantageous compared to running alone in terms of the interest of the exercise, but it is difficult to coordinate the running schedule for many runners.

In addition, since most electronic devices associated with the exercises only manage individual user's exercise records, there are limitations in matching sports events or managing the exercise records among users in different time and space.

Accordingly, there is a need for an audio system for broadcasting running which can provide an environment in which a plurality of runners may exercise together more easily, and minimize the time and space restrictions by taking into consideration the user's exercise environment and preferences.

### SUMMARY OF THE INVENTION

A technical purpose of the present invention is to provide an audio system for broadcasting running in consideration of at least one of running records and running environment information of a specific runner and a method for broadcasting running using the same.

Another technical purpose of the present invention is provide an audio system for broadcasting running and a method for broadcasting running by using the same, which can minimize the restriction in time and space in the running competition between a specific runner and a matching runner.

Still another technical purpose of the present invention is to provide an audio system for broadcasting running and a method for broadcasting running by using the same, which can provide a fair running competition between a specific runner and a matching runner.

The objectives of the present invention are not limited to the above-described ones.

In order to solve the above technical problem, the present invention provides an audio system for broadcasting running.

According to an embodiment, the audio system may include a record management unit configured to manage running records of a specific runner; a runner matching unit configured to recommend candidate matching runners belonging to the other space different from a space of the specific runner and having running records commensurate with the running record of the specific runner; a matching runner information receiving unit for receiving information about a matching runner selected by the specific runner as a running competitor of the specific runner from among the candidate matching runners recommended by the runner matching unit; and a running broadcasting unit for broadcasting a running situation of the specific runner in real time in comparison with one selected from a past time point and a current time point of the matching runner.

According to an embodiment, the runner matching unit may recommend a candidate matching runner having a running record commensurate with the running record of the specific runner by taking a past running record of the candidate matching runner into consideration.

According to an embodiment, the running broadcasting unit may broadcast at least one of distance information, competition information, time information, and a winning plan during a running progress point at which the specific runner proceeds to run, wherein the distance information may include at least one of a running distance run by the specific runner, a remaining distance to be run by the specific runner, a running distance run by the matching runner, a remaining distance to be run by the matching runner, and a difference in the running distance between the specific runner and the matching runner, wherein the competition information may include at least one of a moment when a leading runner is changed between the specific runner and the matching runner, and a moment when the specific runner and the matching runner run side by side, wherein the time information may include at least one of a time elapsed after the specific runner starts running, and a running progress time in comparison with a time record for each running section of the specific runner, and wherein the winning plan may include at least one of a speed difference between the specific runner and the matching runner, a pattern analysis on a running speed of the specific runner, and an advice based on the pattern analysis of the specific runner.

According to an embodiment, the running broadcasting unit may broadcast at least one of ranking information and new running record information of the specific runner at an end point of running at which the specific runner ends running.

According to an embodiment, the audio system may further include a running environment collection unit configured to acquire reference running environment information related to a running environment including at least one of a weather, a temperature, a humidity, an air quality, and a slope on a running path of the specific runner, wherein the runner matching unit may recommend a candidate matching runner belonging to the other space different from a space of the specific runner and having running environment information commensurate with the reference running environment information of the specific runner.

According to an embodiment, at a running preparation point where the specific runner prepares to run, the running broadcasting unit may receive at least one of information about a weak section of the specific runner where the specific runner has a weak running record and information about a strong section of the specific runner where the specific runner has a high running record from the record management unit and broadcasts the information to the specific runner, and the running broadcasting unit may broadcast at least one of information about a weak section of the matching runner where the matching runner has a weak running record and information about a strong section of the matching runner where the matching runner has a high running record to the specific runner.

In order to solve the above technical problem, the present invention provides a method of broadcasting running.

According to an embodiment, the method of broadcasting running may include receiving a request from a specific runner to select a candidate matching runner to compete with the specific runner; acquiring a running record of the specific runner and reference running environment information related to a running environment including at least one of a weather, a temperature, a humidity, an air quality, and a slope on a running path of the specific runner; providing candidate matching runners belonging to the other space different from a space of the specific runner and matching at least one of the running record of the specific runner and the reference running environment information; receiving, from the specific runner, information about a matching runner selected by the specific runner from among the recommended candidate matching runners to compete in running; and broadcasting a running situation of the specific runner in real time in comparison with one selected from a past time point and a current time point of the matching runner, wherein, when the specific runner selects the past time point of the matching runner, the specific runner may perform a competitive run with respect to a past run record of the matching runner, and when the specific runner selects the current time point of the matching runner, the specific runner may perform a competitive run with a real image of the matching runner.

According to an embodiment of the present invention, there is provided an audio system for broadcasting running, which includes a record management unit for managing running records of a specific runner, a running environment collection unit for acquiring reference running environment information related to a running environment including at least one of a weather, a temperature, a humidity, an air quality, and a slope on a running path of the specific runner, a runner matching unit for recommending candidate matching runners belonging to a different space from the specific runner and having running records commensurate with the running record of the specific runner, a matching runner information receiving unit for receiving information about the matching runner selected by the specific runner as a running competitor of the specific runner from among the candidate matching runners recommended by the runner matching unit, and a running broadcasting unit for broadcasting a running situation of the specific runner in real time in comparison with any one selected from a past time point and a current time point of the matching runner.

Accordingly, even when the specific runner selects the past time point of the matching runner, that is, when the specific runner competes with the past running record of the matching runner, it is possible to provide a sense of reality as if the specific runner runs together with the matching runner in real time.

Thus, it is possible to recommend the candidate matching runner belonging to the other space different from the space of the specific runner and commensurate with at least one of the running record and the reference running environment information of the specific runner.

Therefore, the specific runner can do the running competition by selecting at least one of the past running record of the matching runner and a real image of the matching runner, so that the preference of the specific runner can be improved.

In addition, it is possible to provide a fair running competition by taking at least one of the running record and the reference running environment information of the specific runner into consideration.

Further, it is possible to minimize the restriction in time and space by allowing the specific runner to perform the running competition after selecting at least one of the desired date and time of the running competition, the past running record of the matching runner and the real image of the matching runner.

In addition, when the running competition between the specific runner and the matching runner is finished, the running record of the specific runner is managed, and the section in which a leading runner is changed between the specific runner and the matching runner is managed as a highlight section, thereby improving the running skills of the specific runner.

### BRIEF DESCRIPTION OF THE DRAWINGS

The above and other objects, features, and advantages of the present invention will be more apparent from the following detailed description taken in conjunction with the accompanying drawings, in which:

FIG. 1 and FIG. 2 are views for explaining an audio system for broadcasting running according to an embodiment of the present invention.

FIG. 3, FIG. 4, FIG. 5 and FIG. 6 are views for explaining a runner matching request according to an embodiment of the present invention.

FIG. 7, FIG. 8, FIG. 9, FIG. 10, FIG. 11 and FIG. 12 are views for explaining a running environment collection unit according to an embodiment of the present invention.

FIG. 13, FIG. 14, FIG. 15 and FIG. 16 are views for explaining a runner matching unit according to an embodiment of the present invention.

FIG. 17 is a view for explaining a matching runner information receiving unit according to an embodiment of the present invention.

FIG. 18, FIG. 19, FIG. 20, FIG. 21, FIG. 22, FIG. 23, FIG. 24, FIG. 25, FIG. 26, FIG. 27 and FIG. 28 are views for explaining a running broadcasting unit according to an embodiment of the present invention.

FIG. 29 and FIG. 30 are views for explaining a record management unit according to an embodiment of the present invention.

FIG. 31 is a flowchart for explaining a method for broadcasting running according to an embodiment of the present invention.

### DETAILED DESCRIPTION OF THE EMBODIMENTS

Hereinafter, preferred embodiments of the present invention will be described in detail with reference to the accompanying drawings. However, the technical spirit of the present invention is not limited to the embodiments, but may be realized in different forms. The embodiments introduced here are provided to sufficiently deliver the spirit of the present invention to those skilled in the art so that the disclosed contents may become thorough and complete.

When it is mentioned in the specification that one element is on another element, it means that the first element may be directly formed on the second element or a third element may be interposed between the first element and the second element. Further, in the drawings, the thicknesses of the membrane and areas are exaggerated for efficient description of the technical contents.

Further, in the various embodiments of the present invention, the terms such as first, second, and third are used to describe various elements, but the elements are not limited to the terms. The terms are used only to distinguish one element from another element. Accordingly, an element mentioned as a first element in one embodiment may be mentioned as a second element in another embodiment. The embodiments illustrated here include their complementary embodiments. Further, the term “and/or” in the specification is used to include at least one of the elements enumerated in the specification.

In the specification, the terms of a singular form may include plural forms unless otherwise specified. Further, the terms “including” and “having” are used to designate that the features, the numbers, the steps, the elements, or combination thereof described in the specification are present, and may be understood that one or more other features, numbers, step, elements, or combinations thereof may be added.

In addition, the terms portion“, group”, “module”, and the like described in the specification mean a unit that processes at least one function or operation, which may be implemented by hardware or software or a combination of hardware and software.

Further, in the following description of the present invention, a detailed description of known functions and configurations incorporated herein will be omitted when it may make the subject matter of the present invention unnecessarily unclear.

As used herein, the term “specific runner SR” may be understood as a running racer who performs the running competition with a matching runner MR selected by the specific runner from among candidate matching runners recommended through an audio system for broadcasting running according to an embodiment of the present invention.

In addition, the term “matching runner MR” may be understood as an opponent racer who performs the running competition and is selected through the audio system for broadcasting running by the specific runner SR.

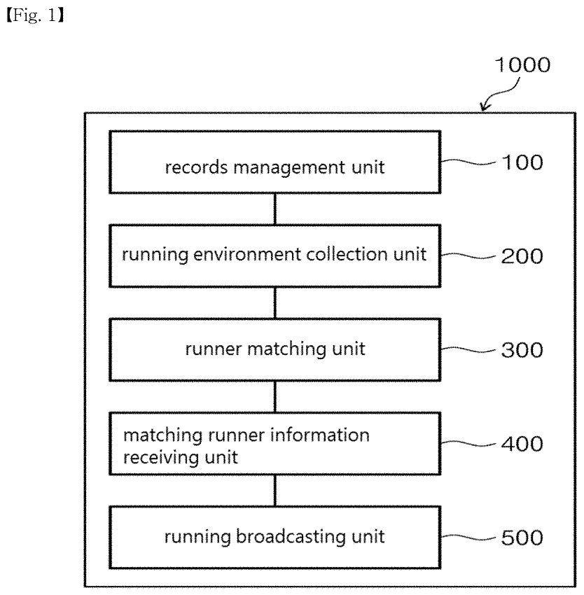

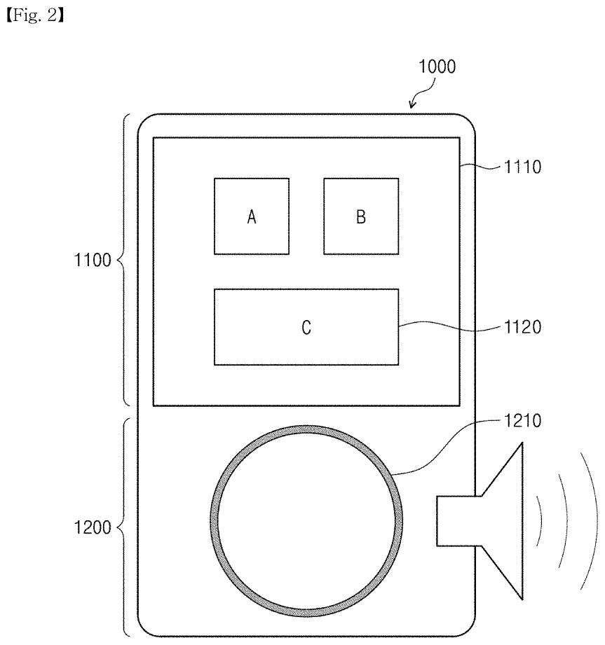

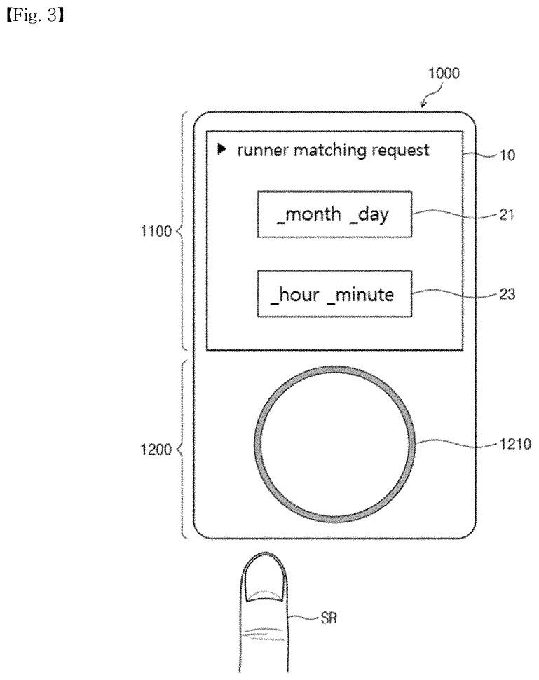

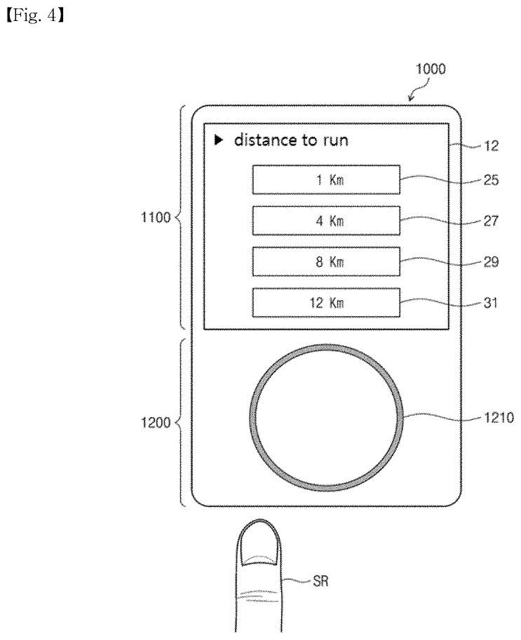

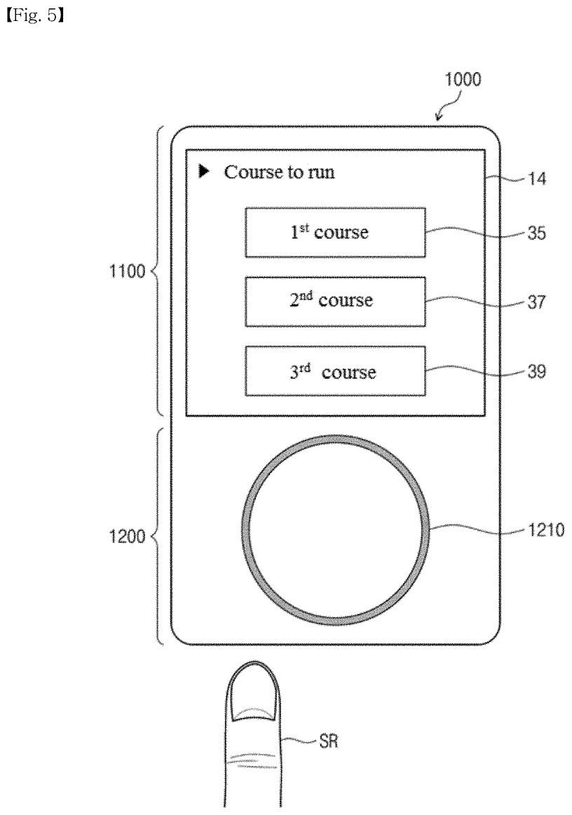

FIGS. 1 and 2 are views for explaining an audio system for broadcasting running according to an embodiment of the present invention.

Referring to FIG. 1, an audio system 1000 for broadcasting running may include at least one of a record management unit 100, a running environment collection unit 200, a runner matching unit 300, a matching runner information receiving unit 400, and a running broadcasting unit 500.

According to one embodiment, the record management unit 100 may manage a running record of the specific runner SR. In addition, the record management unit 100 may not only manage the record of the specific runner SR, but also provide the specific runner SR with a record of a previous running competition of the managed specific runner SR. Thus, the specific runner SR may prepare and plan a next running competition based on the record of the previous running competition.

According to one embodiment, the running environment collection unit 200 may acquire reference running environment information associated with a running environment including at least one of a weather, a temperature, a humidity, an air quality, and a slope on a running path of the specific runner SR. Accordingly, the running environment collection unit 200 may provide the reference running environment information related to the running environment on the running path of the specific runner SR to the runner matching unit 300.

According to one embodiment, the runner matching unit 300 may receive at least one of a running record of the specific runner SR from the record management unit 100 and the reference running environment information from the running environment collection unit 200.

Thus, the runner matching unit 300 may recommend the matching runner MR belonging to the other space different from a space of the specific runner SR, having the running record commensurate with the running record of the specific runner SR and matching one of the running environment related to the reference running environment of the specific runner SR.

In the present specification, the other space signifies a space that is physically spaced such as other countries or other cities, and may be understood as a concept that includes physically spaced spaces even in the same country and the same city. In other respects, it can be understood as a term for distinguishing the running from the conventional gathering and running.

Alternatively, the runner matching unit 300 may recommend the matching runner MR belonging to a space the same as a space of the specific runner SR and a time different from a time of the specific runner SR. In this case, the expression “the matching runner MR belonging to a space the same as a space of the specific runner SR and a time different from a time of the specific runner SR” may include a concept that the specific runner SR runs against the running record of the matching runner MR and it can be understood as the expression for distinguishing the running from the conventional gathering and running.

That is, according to an embodiment of the present invention, the runner matching unit 300 may recommend the matching runner MR to the specific runner SR by taking into consideration at least one of the running record and the reference running environment information of the specific runner SR, so the specific runner SR can perform a fair running competition.

According to one embodiment, the matching runner information receiving unit 400 may receive, from the specific runner SR, information about the matching runner MR who is selected by the specific runner SR as a running competitor from among candidate matching runners recommended by the runner matching unit 300.

According to one embodiment, when the matching runner information receiving unit 400 receives the information about the selected matching runner MR from the specific runner SR and the running competition proceeds between the specific runner SR and the matching runner MR, the running broadcasting unit 500 may broadcast the running situation of the specific runner SR and the matching runner MR to the specific runner SR in real time.

In detail, the running broadcasting unit 500 may broadcast the running situation to the specific runner SR at a time point including at least one of a running preparation time point at which the specific runner SR prepares to run, a running progress time point at which the specific runner SR runs, and a running end time point at which the specific runner SR ends to run.

More specifically, at the running preparation time point, the running broadcasting unit 500 may broadcast at least one of a weak running section of the specific runner SR, a strong running section of the specific runner SR, a weak running section of the matching runner MR, and a strong running section of the matching runner MR.

In addition, at the running progress time point, the running broadcasting unit 500 may broadcast at least one of distance information, competition information, time information, and a winning plan.

Further, at the running end time point, the running broadcasting unit 500 may broadcast at least one of running ranking information and new running record information of the specific runner SR.

Referring to FIG. 2, the audio system 1000 for broadcasting running may include at least one of a view providing unit 1100 and a sound providing unit 1200.

According to one embodiment, the view providing unit 1100 may provide the specific runner SR with at least one of a screen 1110 and a selection button 1120.

More specifically, the view providing unit 1100 may provide the screen 1110 in order to provide the specific runner SR with predetermined information from at least one of the record management unit 100, the running environment collection unit 200, the runner matching unit 300, the matching runner information receiving unit 400, and the running broadcasting unit 500.

In addition, the view providing unit 1100 provides the selection button 1120 to allow the specific runner SR to select the predetermined information when the predetermined information is provided to the specific runner SR through the screen 1110.

According to one embodiment, the sound providing unit 1200 may include a speaker 1210.

Accordingly, the sound providing unit 1200 may provide the sound through the speaker 1210 corresponding to the contents in the screen 1110 provided by the view providing unit 1100.

In more detail, the sound providing unit 1200 may provide the specific runner SR with the sound through the speaker 1210 when the view providing unit 1100 provides the specific runner SR with the screen 1110 including the predetermined information transmitted from at least one of the record management unit 100, the running environment collection unit 200, the runner matching unit 300, the matching runner information receiving unit 400, and the running broadcasting unit 500.

Accordingly, the specific runner SR may hear and recognize the running situation in real time at the time point including at least one of the running preparation time point, the running progress time point, and the running end time point.

In the embodiments described below, as described above, the sound corresponding to the predetermined information display on the screen 1110 of the view providing unit 1100 may be provided through the speaker 1210 of the sound providing unit 1200 and detailed description thereof will be omitted.

As described above, during the running competition between the specific runner SR and the matching runner MR, the above-described audio system 1000 for broadcasting running may provide the specific runner SR with information about the candidate matching runners commensurate with at least one of the running record and the reference running environment information of the specific runner SR, and receive information about the matching runner MR selected by the specific runner SR as the running competitor from among the recommended candidate matching runners, thereby broadcasting the running situation of the specific runner SR in real time.

For this purpose, according to an embodiment, the audio system 1000 for broadcasting running may be provided in the form of a wearing device being worn on a part of a body of the specific runner SR.

For example, the audio system 1000 for broadcasting running may be provided in the form of a wearable device, more specifically, a wrist watch being worn on a wrist portion of the specific runner SR.

Alternatively, for example, the audio system 1000 for broadcasting running may be provided in the form of a wearable device being worn on a head of the specific runner SR, more specifically, in the form of a headset.

In addition, as another example, the audio system 1000 for broadcasting running may be provided in the form of a wearable device being worn on a waist of the specific runner SR, more specifically, in the form of a device being worn on a belt or a belt loop.

As described above, since the audio system 1000 for broadcasting running can be provided in the form of a wearable device being worn on a part of a body of the specific runner SR, even if the specific runner SR moves while running, the audio system 1000 can readily broadcast the running situation without being separated from the body of the specific runner SR.

Alternatively, according to another embodiment, the audio system 1000 for broadcasting running may be provided in the form of an application installed in a device of the specific runner SR.

For example, the audio system 1000 for broadcasting running may be provided in the form of an application installed in a mobile phone of the specific runner SR.

Hereinafter, the configuration of the audio system 1000 for broadcasting running according to an embodiment of the present invention will be described in more detail with reference to the drawings.

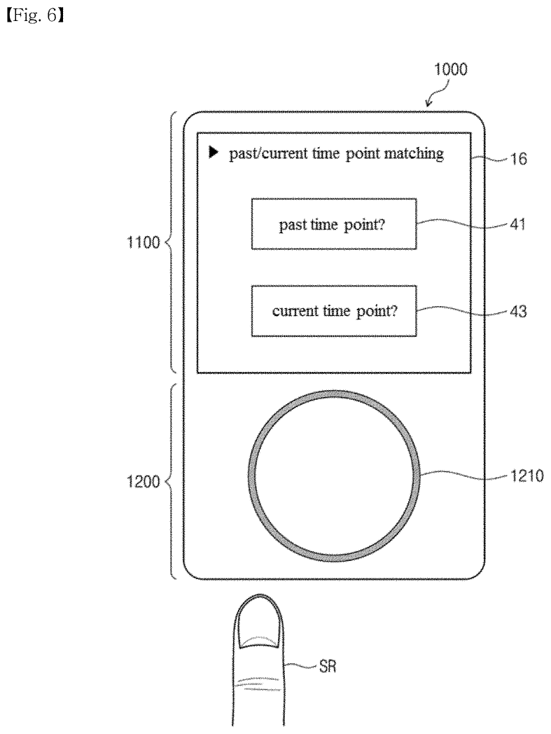

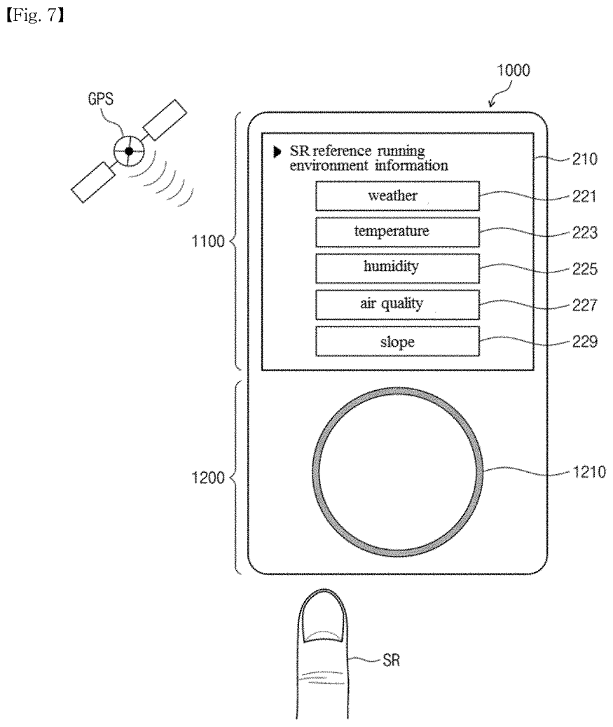

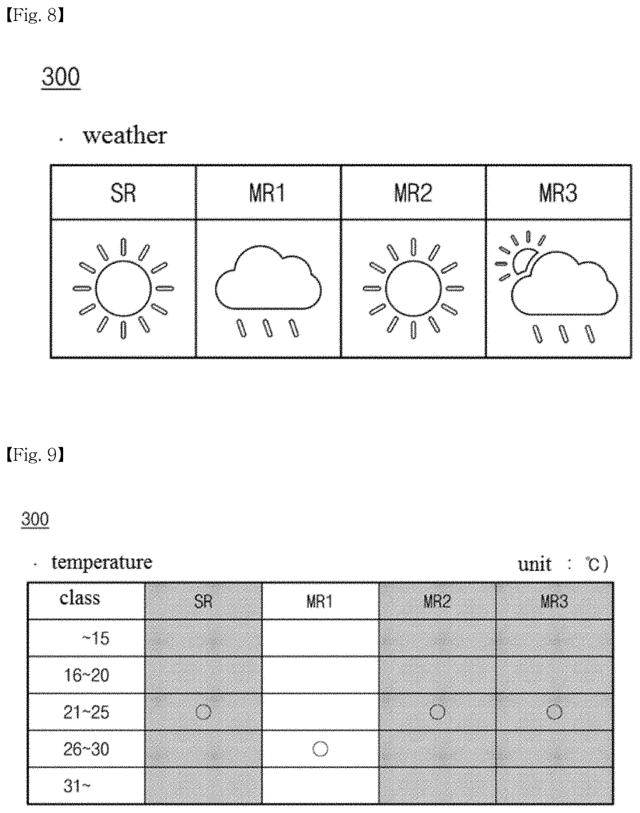

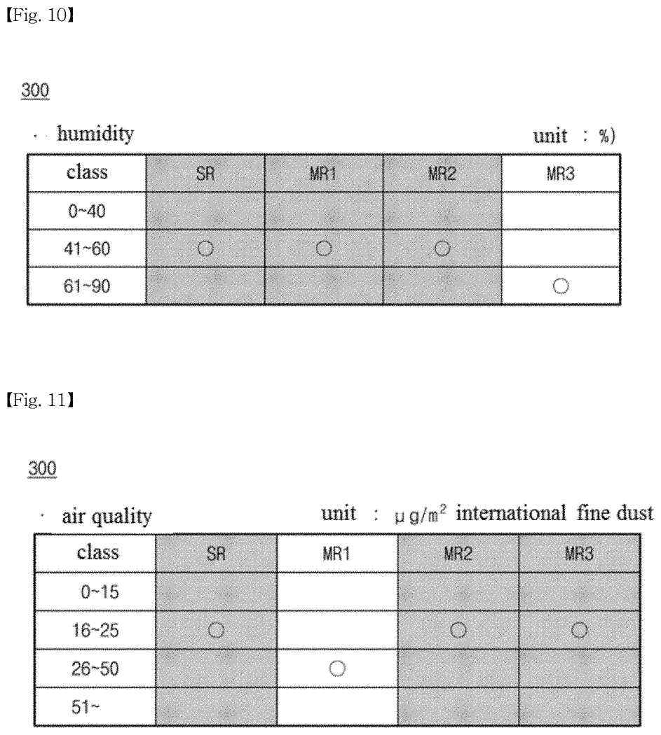

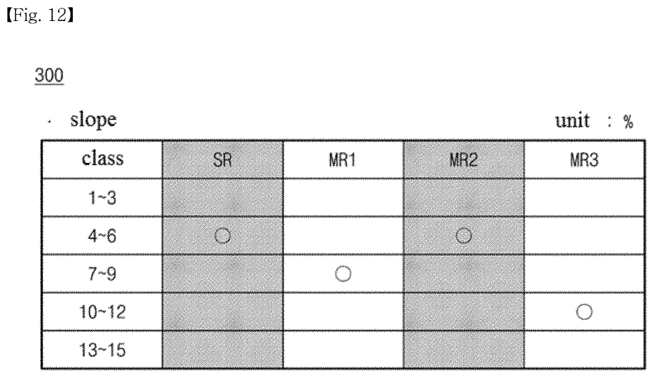

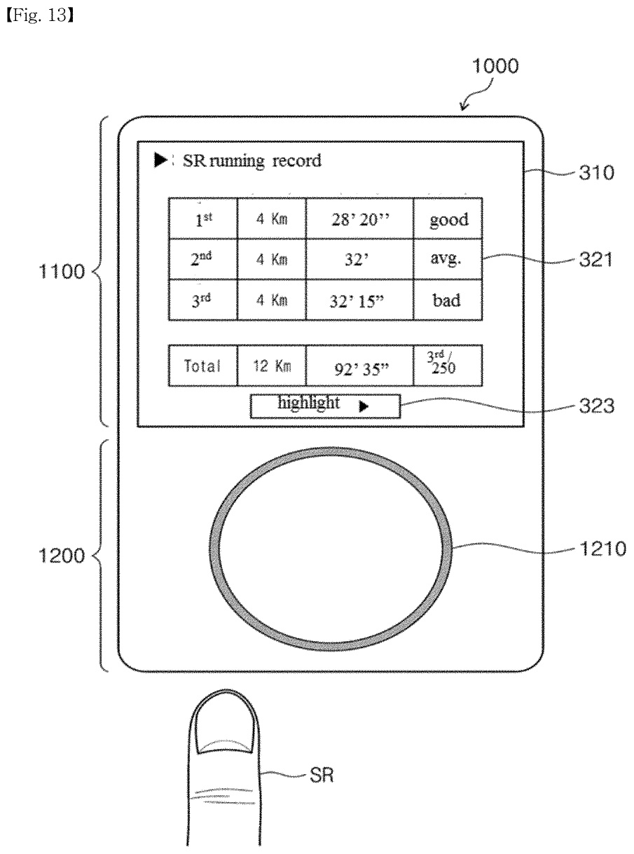

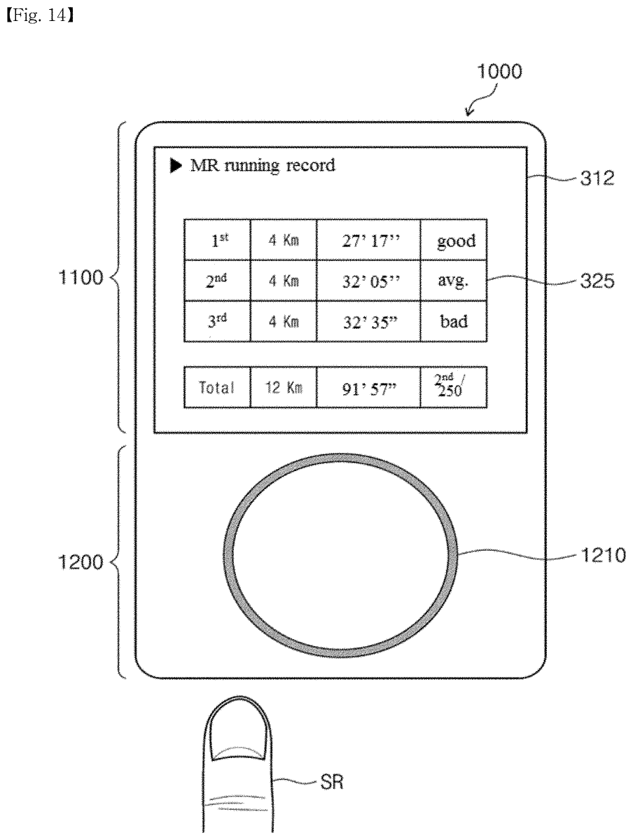

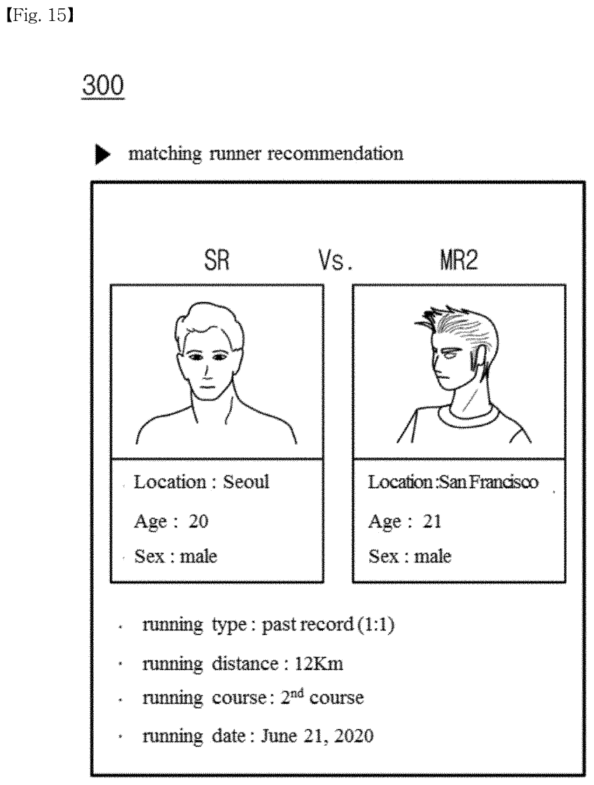

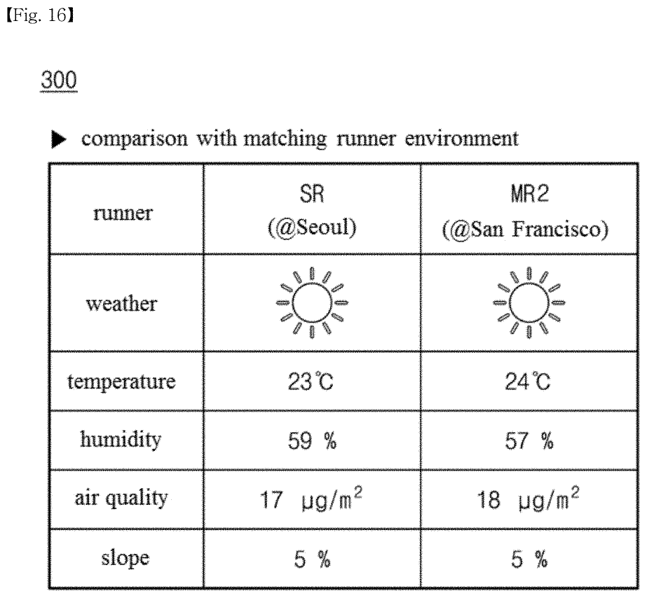

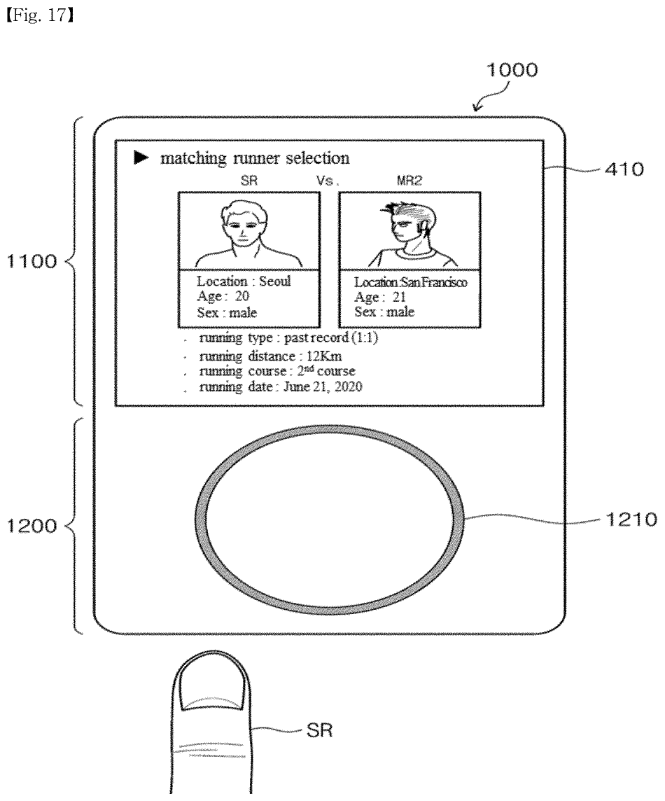

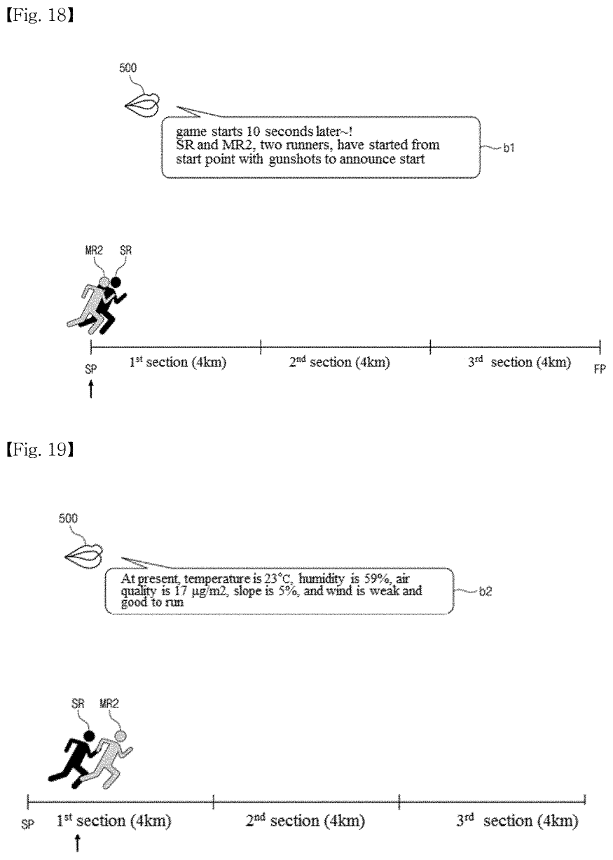

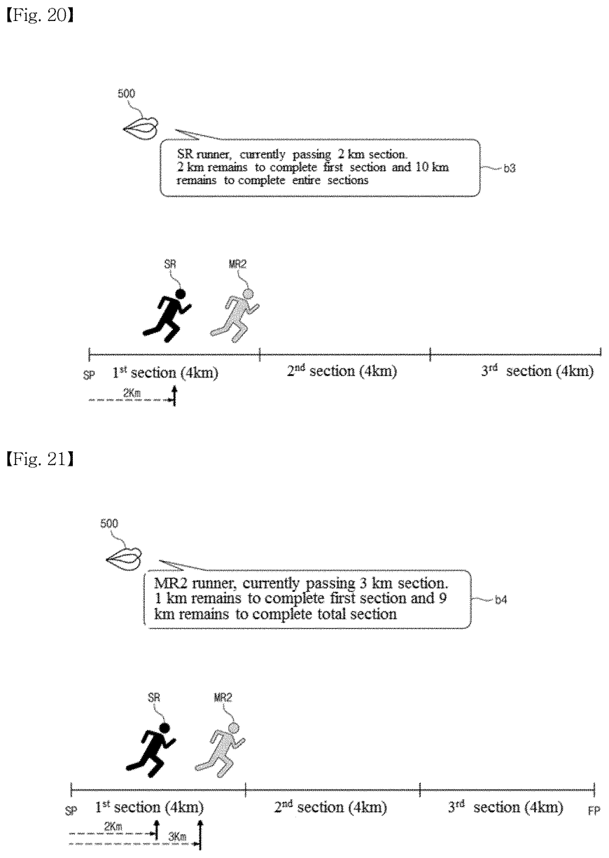

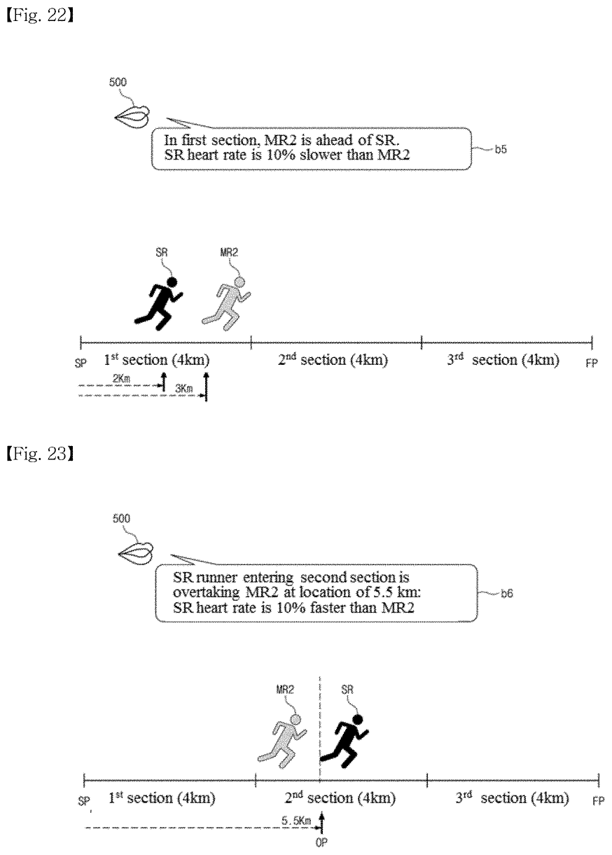

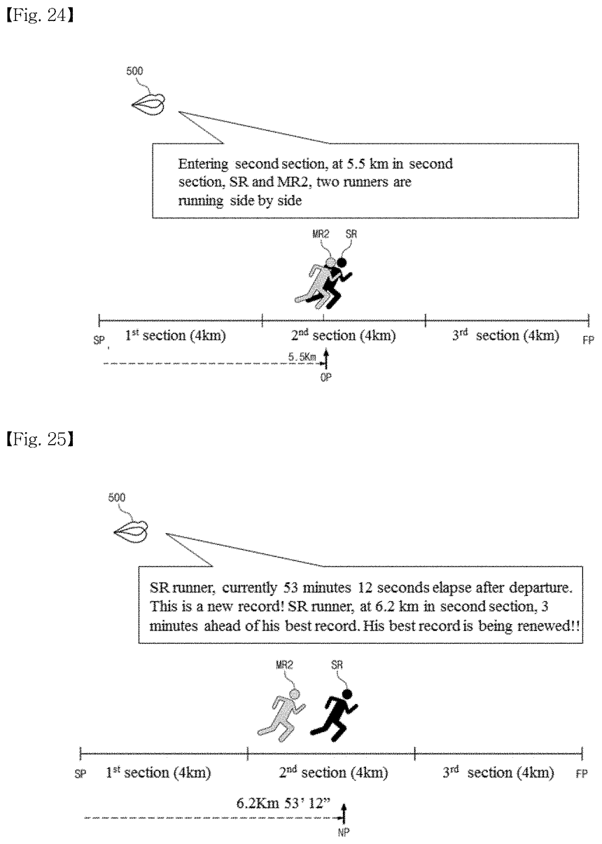

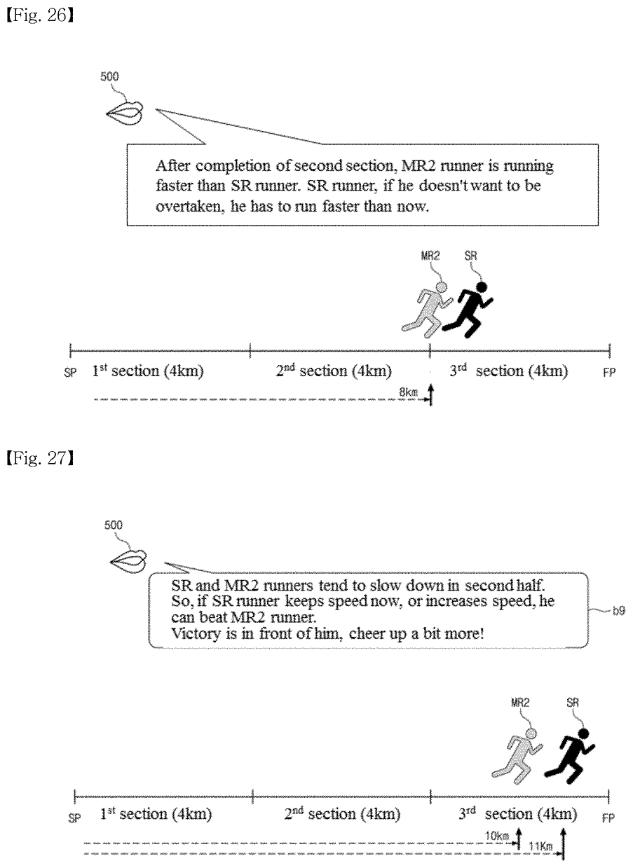

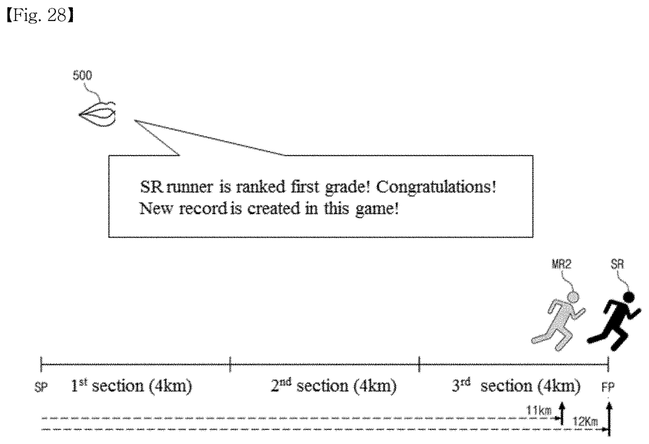

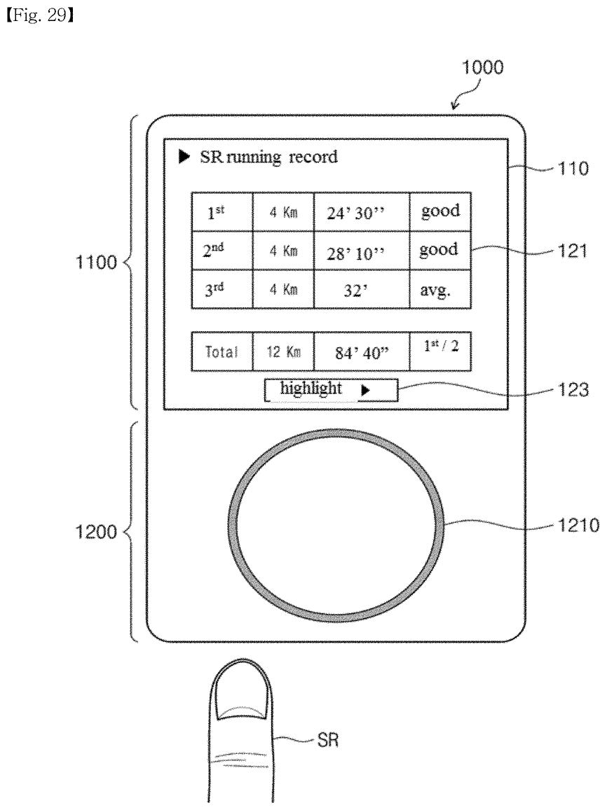

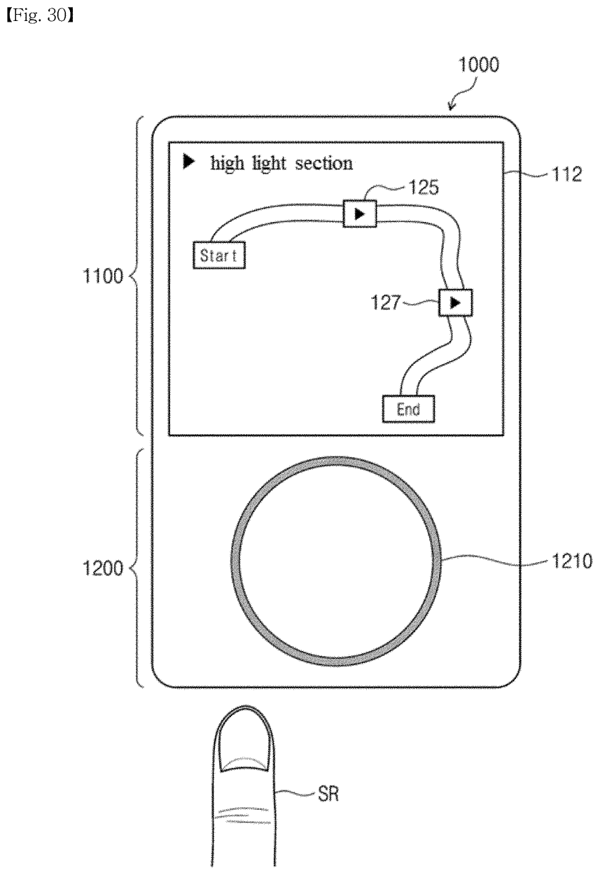

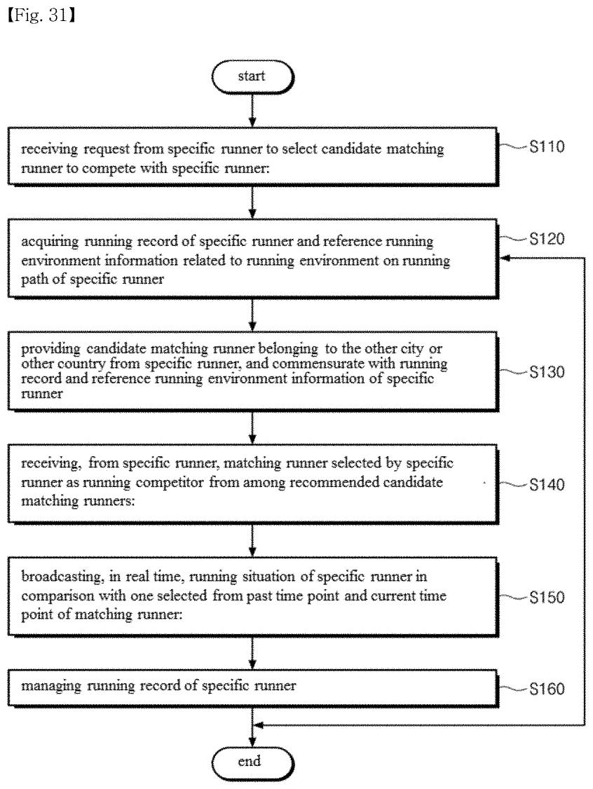

FIGS. 3 to 6 are views for explaining a runner matching request according to an embodiment of the present invention, FIGS. 7 to 12 are views for explaining a running environment collection unit according to an embodiment of the present invention, FIGS. 13 to 16 are views for explaining a runner matching unit according to an embodiment of the present invention, FIG. 17 is a view for explaining a matching runner information receiving unit according to an embodiment of the present invention, FIGS. 18 to 28 are views for explaining a running broadcasting unit according to an embodiment of the present invention, FIGS. 29 and 30 are views for explaining a record management unit according to an embodiment of the present invention, and FIG. 31 is a flowchart for explaining a method for broadcasting running according to an embodiment of the present invention.

Referring to FIG. 3, the matching runner information receiving unit 400 may receive a request for matching a running competition from the specific runner SR.

More specifically, as shown in FIG. 3, the matching runner information receiving unit 400 may provide the specific runner SR with a “runner matching request” screen 10. For example, the matching runner information receiving unit 400 may provide at least one of a “date (_ month _ day)” input button 21 and a “time (_ hour _ minute)” input button 23 for the running competition on the “runner matching request” screen 10 shown in FIG. 3.

Accordingly, the specific runner SR can input at least one of the date and time for the running competition by touch at least one of the “date” input button 21 and the “time” input button 23.

That is, according to an embodiment of the present invention, the matching runner information receiving unit 400 may provide at least one of the “date” input button 21 and the “time” input button 23 on the “runner matching request” screen 10 to acquire runner matching request information input by the specific runner SR.

In addition, the matching runner information receiving unit 400 may receive information on a distance to run from the specific runner SR.

More specifically, as shown in FIG. 4, the matching runner information receiving unit 400 may provide the specific runner SR with a “distance to run” screen 12. For example, the matching runner information receiving unit 400 may provide at least one of a “1 Km” selection button 25, a “4 Km” selection button 27, a “8 Km” selection button 29, and a “12 Km” selection button 31 on the “distance to run” screen 12 shown in FIG. 4.

Accordingly, the specific runner SR can select the distance to run by touching at least one of the “1 Km” selection button 25, the “4 Km” selection button 27, the “8 Km” selection button 29, and the “12 Km” selection button 31.

That is, according to an embodiment of the present invention, the matching runner information receiving unit 400 may provide at least one of the “1 Km” selection button 25, the “4 Km” selection button 27, the “8 Km” selection button 29, and the “12 Km” selection button 31 on the “distance to run” screen 12 to acquire information about the distance to run selected by the specific runner SR.

In addition, the matching runner information receiving unit 400 may receive information on a course to be run from the specific runner SR.

More specifically, as shown in FIG. 5, the matching runner information receiving unit 400 may provide the specific runner SR with a “course to run” screen 14. For example, the matching runner information receiving unit 400 may provide at least one of a “first course” selection button 35, a “second course” selection button 37, and a “third course” selection button 39 on the “course to run” screen 14 shown in FIG. 5.

Accordingly, the specific runner SR can select the course to run by touching at least one of the “first course” selection button 35, the “second course” selection button 37, and the “third course” selection button 39.

That is, according to an embodiment of the present invention, the matching runner information receiving unit 400 may provide at least one of the “first course” selection button 35, the “second course” selection button 37, and the “third course” selection button 39 on the “course to run” screen 14 to acquire information on the course to run selected by the specific runner SR.

In this case, when the specific runner SR touches the buttons 35 to 39 shown in FIG. 5, the matching runner information receiving unit 400 may provide a map screen corresponding to the courses (that is, the first to third courses) on the screen 14 for acquiring information on the courses to run.

In detail, the information on the course to be run may include at least one of information about an altitude, a distance, and a terrain of the course to be run selected by the specific runner SR.

In addition, the matching runner information receiving unit 400 may receive information on a matching time point to run from the specific runner SR.

More specifically, as shown in FIG. 6, the matching runner information receiving unit 400 may provide the specific runner SR with a “past/current time point matching” screen 16. For example, the matching runner information receiving unit 400 may provide at least one of a “past time point matching?” selection button 41 and a “current time point matching?” selection button 43 on the “past/current time point matching” screen 16 shown in FIG. 6.

Accordingly, the specific runner SR can select the matching time point to run by touching at least one of the “past time point matching?” selection button 41 and the “current time point matching?” selection button 43.

That is, according to an embodiment of the present invention, the matching runner information receiving unit 400 may provide at least one of the “past time point matching?” selection button 41 and the “current time point matching?” selection button 43 on the “past/current time point matching” screen 16, to acquire information on the matching time point to run selected by the specific runner SR.

The past time point matching may be understood as a concept that the specific runner SR matches with a past running record of the matching runner MR selected by the specific runner SR as a running competitor.

That is, the matching runner information receiving unit 400 may provide at least one of the “past time point matching?” selection button 41 and the “current time point matching?” selection button 43 on the “past/current time point matching” screen 16, and when the specific runner SR selects the “past time point matching?” selection button 41, the specific runner SR may perform the running competition against the past run record of the matching runner MR. Alternatively, when the specific runner SR selects the “current time point matching?” selection button 43, the specific runner SR may perform the running competition with the real image of the matching runner MR.

When the matching runner information receiving unit 400 receives a runner matching request including at least one of information about the date or time to run, the running distance, the running course, and the past/present time point matching, the running environment collection unit 200 may receive the reference running environment information related to the running environment including at least one of the weather, the temperature, the humidity, the air quality, and the slope on the running path of the specific runner SR.

More specifically, according to one embodiment, the running environment collection unit 200 may provide the specific runner SR with a “specific runner reference running environment information” screen 210 as shown in FIG. 7. For example, the running environment collection unit 200 may provide at least one of a “weather” input button 221, a “temperature” input button 223, a “humidity” input button 225, an “air quality” input button 227, and a “slope” input button 229 on the “specific runner reference running environment information” screen 210 shown in FIG. 7.

Accordingly, the specific runner SR may input the reference running environment information of the specific runner SR by touching at least one of the “weather” input button 221, the “temperature” input button 223, the “humidity” input button 225, the “air quality” input button 227, and the “slope” input button 229.

That is, according to an embodiment of the present invention, the running environment collection unit 200 may acquire the reference running environment information of the specific runner SR by providing at least one of the “weather” input button 221, the “temperature” input button 223, the “humidity” input button 225, the “air quality” input button 227, and the “slope” input button 229 on the “specific runner reference running environment information” screen 210.

Alternatively, according to another embodiment, as shown in FIG. 7, the running environment collection unit 200 may automatically receive the reference running environment information related to the running environment including at least one of the weather, the temperature, the humidity, the air quality, and the slope on the running path of a region where the specific runner SR is located, based on GPS.

In this case, when the running environment collection unit 200 automatically receives the reference running environment information based on the GPS, the automatically received reference running environment information may be provided on the “specific runner reference running environment information” screen 210. Accordingly, the specific runner SR may check the automatically received reference running environment information provided on the “specific runner reference running environment information” screen 210 and may input a real running environment by touching the buttons 221 to 229 shown in FIG. 7 when it is determined that the automatically received reference running environment information is different from the real running environment.

That is, according to an embodiment of the present invention, the running environment collection unit 200 may not only automatically receive the reference running environment information based on the GPS, but also receive the modified reference running environment information from the specific runner SR. Accordingly, the running environment collection unit 200 may acquire information on the accurate running environment.

When the running environment collection unit 200 acquires the reference running environment information related to the running environment including at least one of the weather, the temperature, the humidity, the air quality, and the slope on the running path of the specific runner from at least one of the specific runner SR and the GPS, the runner matching unit 300 may recommend the matching runner MR belonging to the other space different from the space of the specific runner SR and having the running environment information commensurate with the reference running environment information of the specific runner SR.

Hereinafter, an algorithm for recommending a candidate matching runner having running environment information commensurate with the reference running environment information of the specific runner SR in the runner matching unit 300 will be described.

Referring to FIG. 8, the runner matching unit 300 may acquire information on the weather on the running path of the specific runner SR included in the reference running environment information and acquired from the running environment collection unit 200.

For example, the weather on the running path of the specific runner SR acquired from the running environment collection unit 200 may be a fine weather. In addition, the weather on the running path of a first preliminary matching runner MR1 may be a rainy weather, the weather on the running path of a second preliminary matching runner MR2 may be a fine weather, and the weather on the running path of a third preliminary matching runner MR3 may be a slightly cloudy weather.

Accordingly, the runner matching unit 300 may acquire information about the fine weather on the running path of the specific runner SR, the rainy weather on the running path of the first preliminary matching runner MR1, the fine weather on the running path of the second preliminary matching runner MR2, and the slightly cloudy weather on the running path of the third preliminary matching runner MR3, which are acquired from the running environment collection unit 200, in order to match the weather on the running path of the specific runner SR with weathers of first to third preliminary matching runners MR1 to MR3.

Therefore, the runner matching unit 300 may select the second preliminary matching runner MR2 subject to the fine weather, which is commensurate with the weather on the running path of the specific runner SR, as a candidate matching runner.

Referring to FIG. 9, the runner matching unit 300 may acquire information about the temperature of the reference running environment information on the running path of the specific runner SR acquired from the running environment collection unit 200.

For example, the temperature on the running path of the specific runner SR acquired from the running environment collection unit 200 may be in the range of 21° C. to 25° C. In addition, the temperature on the running path of the first preliminary matching runner MR1 may be in the range of 26° C. to 30° C., and the temperature on the running path of the second and third preliminary matching runners MR2 and MR3 may be in the range of 21° C. to 25° C.

Accordingly, the runner matching unit 300 may acquire information about the temperature range of 21° C. to 25° C. on the running path of the specific runner SR, the temperature range of 26° C. to 30° C. on the running path of the first preliminary matching runner MR1, and the temperature range of 21° C. to 25° C. on the running path of the second and third preliminary matching runners MR2 and MR3, which are acquired from the running environment collection unit 200, in order to match the temperature range on the running path of the specific runner SR with the temperature range of first to third preliminary matching runners MR1 to MR3.

Therefore, the runner matching unit 300 may select the second and third preliminary matching runners MR2 and MR3 having the temperature range, which is commensurate with the temperature range 21° C. to 25° C. on the running path of the specific runner SR, as candidate matching runners.

Referring to FIG. 10, the runner matching unit 300 may acquire information about the humidity of the reference running environment information on the running path of the specific runner SR acquired from the running environment collection unit 200.

For example, the humidity on the running path of the specific runner SR acquired from the running environment collection unit 200 may be in the range of 41% to 60%. In addition, the humidity on the running path of the first and second preliminary matching runners MR1 and MR2 may be in the range of 41% to 60%, and the humidity on the running path of the third preliminary matching runner MR3 may be in the range of 61% to 90%.

Accordingly, the runner matching unit 300 may acquire information about the humidity range of 41% to 60% on the running path of the specific runner SR, the humidity range of 41% to 60% on the running path of the first and second preliminary matching runners MR1 and MR2, and the humidity range of 61% to 90% on the running path of the third preliminary matching runner MR3, which are acquired from the running environment collection unit 200, in order to match the humidity range on the running path of the specific runner SR with the humidity range of first to third preliminary matching runners MR1 to MR3.

Therefore, the runner matching unit 300 may select the first and second preliminary matching runners MR1 and MR2 having the humidity range, which is commensurate with the humidity range of 41% to 60% on the running path of the specific runner SR, as candidate matching runners.

Referring to FIG. 11, the runner matching unit 300 may acquire information about the air quality of the reference running environment information on the running path of the specific runner SR acquired from the running environment collection unit 200.

For example, the air quality on the running path of the specific runner SR acquired from the running environment collection unit 200 may be in the range of 16 μg/m² to 25 μg/m 2. In addition, the air quality on the running path of the first preliminary matching runner MR1 may be in the range of 26 μg/m² to 50 μg/m², and the air quality on the running path of the second and third preliminary matching runners MR2 and MR3 may be in the range of 16 μg/m² to 25 μg/m².

Accordingly, the runner matching unit 300 may acquire information about the air quality range of 16 μg/m² to 25 μg/m on the running path of the specific runner SR, the air quality range of 26 μg/m² to 50 μg/m on the running path of the first preliminary matching runner MR1, and the air quality range of 16 μg/m² to 25 μg/m on the running path of the second and third preliminary matching runners MR2 and MR3, which are acquired from the running environment collection unit 200, in order to match the air quality range on the running path of the specific runner SR with the air quality range of first to third preliminary matching runners MR1 to MR3.

Therefore, the runner matching unit 300 may select the second and third preliminary matching runners MR1 and MR2 having the air quality range, which is commensurate with the air quality range of 16 μg/m² to 25 μg/m on the running path of the specific runner SR, as candidate matching runners.

In addition, referring to FIG. 12, the runner matching unit 300 may acquire information about the slope of reference running environment information on the running path of the specific runner SR acquired from the running environment collection unit 200.

For example, the slope on the running path of the specific runner SR acquired from the running environment collection unit 200 may be in the range of 4% to 6%. In addition, the slope on the running path of the first preliminary matching runner MR1 may be in the range of 7% to 9%, the slope on the running path of the second preliminary matching runner MR2 may be in the range of 4% to 6%, and the slope on the running path of the third preliminary matching runner MR3 may be in the range of 10% to 12%.

Accordingly, the runner matching unit 300 may acquire information about the slope range of 4% to 6% on the running path of the specific runner SR, the slope range of 7% to 9% on the running path of the first preliminary matching runner MR1, the slope range of 4% to 6% on the running path of the second preliminary matching runner and MR2, and the slope range of 10% to 12% on the running path of the third preliminary matching runner MR3, which are acquired from the running environment collection unit 200, in order to match the slope range on the running path of the specific runner SR with the slope range of first to third preliminary matching runners MR1 to MR3.

Therefore, the runner matching unit 300 may select the second preliminary matching runner having the slope range, which is commensurate with the slope range of 4% to 6% on the running path of the specific runner SR, as a candidate matching runner.

As described above, the runner matching unit 300 may recommend the candidate matching runner having the running environment information commensurate with the reference running environment information of the specific runner SR. According to the above-described embodiments, the runner matching unit 300 may recommend the second candidate matching runner MR2 as a final candidate matching runner by collectively taking into consideration the second candidate matching runner MR2 commensurate with the weather environment of the specific runner SR, the second and third candidate matching runners MR2 and MR3 commensurate with the temperature environment of the specific runner SR, the first and second candidate matching runners MR1 and MR2 commensurate with the humidity environment of the specific runner SR, the second and third candidate matching runners MR2 and MR3 commensurate with the air quality environment of the specific runner SR, and the second candidate matching runner MR2 commensurate with the slope environment of the specific runner SR.

According to one embodiment, the runner matching unit 300 may recommend a candidate matching runner belonging to the other space different from a space of the specific runner SR and having a running record commensurate with the running record of the specific runner SR.

For this purpose, the runner matching unit 300 may receive the running record of the specific runner SR from the record management unit 100.

More specifically, referring to FIG. 13, the runner matching unit 300 may receive information on a previous running record of the specific runner SR from the record management unit 100, for example, the previous running record of the specific runner SR for at least one of the first to third sections and the total section, or information of the previous running record on the highlight section.

In this case, the runner matching unit 300 may provide the information about the previous running record of the specific runner SR, which is provided from the record management unit 100, on the “specific runner running record” screen 310. Accordingly, the specific runner SR may check the previous running record of the specific runner SR through the “specific runner running record” screen 310.

Alternatively, the runner matching unit 300 may provide selection buttons, for example, at least one of a section-specific record confirmation button 321 and a highlight button 323 to allow the specific runner SR to confirm the detail of the previous running record of the specific runner SR by touching the “specific runner running record” screen 310.

That is, the runner matching unit 300 not only selects and recommends the candidate matching runner commensurate with the previous running record of the specific runner SR by receiving the previous running record of the specific runner SR from the record management unit 100, but also provide the specific runner SR with information or detailed information about the previous running record of the specific runner SR by providing the selection buttons 321 and 323 on the “specific runner running record” screen 310.

Meanwhile, referring to FIG. 14, the runner matching unit 300 may search for the candidate matching runners commensurate with the previous running record of the specific runner SR based on the previous running record of the specific runner SR provided from the record management unit 100.

More specifically, it is possible to search for the candidate matching runners commensurate with the information on the previous running record of the specific runner SR shown in FIG. 13, for example, the information on the previous running record of the specific runner SR for at least one of the first to third sections and total section.

For example, referring to FIG. 13, when examining the evaluation for each running section of the specific runner SR provided to the runner matching unit 300 from the record management unit 100, the first section is good, the second section is normal, and the third section is bad. In this case, the runner matching unit 300 may search for the candidate matching runner commensurate with the evaluation for each running section of the specific runner SR.

For example, as shown in FIG. 14, the runner matching unit 300 may search for the candidate matching runner commensurate with ‘good’, which is an evaluation for the first section of the specific runner SR. Alternatively, the runner matching unit 300 may search for the candidate matching runner commensurate with ‘normal’, which is an evaluation for the second section of the specific runner SR. Otherwise, the runner matching unit 300 may search for the candidate matching runner commensurate with ‘bad’, which is an evaluation for the third section of the specific runner SR. Further, it is possible to search for the candidate matching runner commensurate with the evaluation for the first section of ‘good’, the second section of ‘normal’, and the third section of ‘bad’.

In this case, the runner matching unit 300 may provide information on the running record of the candidate matching runner on a “matching runner running record” screen 312. Accordingly, the specific runner SR may check the running record of the candidate matching runner MR through the “matching runner running record” screen 312.

Alternatively, the runner matching unit 300 may provide a selection button, for example, at least one of a section-specific record confirmation button 325 to allow the specific runner SR to confirm the detail of the running record of the matching runner MR by touching the “matching runner running record” screen 312.

That is, the runner matching unit 300 not only receives the previous running record of the specific runner SR from the record management unit 100 and provides the specific runner SR with the information on the previous running record, but also provides the section-specific record confirmation button 325 through the “matching runner running record” screen 312 for the matching runner, thereby providing the specific runner SR with information or detailed information for the running record of the candidate matching runner.

Thus, as shown in FIG. 15, the runner matching unit 300 can recommend the second candidate matching runner MR2 having the running record commensurate with the previous running record of the specific runner SR as the final candidate matching runner by taking into consideration both the previous running record of the specific runner SR shown in FIG. 13 and the running record of the candidate matching runner shown in FIG. 14.

In this case, the runner matching unit 300, as described above, may consider information on each running competition selected or input by the specific runner SR, for example, at least one of the date (day and time) of FIG. 3 for performing the running competition, The distance to run of FIG. 4, the course to run of FIG. 5, and the running type (past/current time point matching) of FIG. 6.

Meanwhile, when the second candidate matching runner MR2 having the running record commensurate with the previous running record of the specific runner SR is selected, as shown in FIG. 16, the runner matching unit 300 may compare the running environment of the second candidate matching runner MR2 with the running environment of the specific runner SR.

In this case, as shown in FIG. 16, the runner matching unit 300 compares the reference running environment information of the specific runner SR with the running environment of the second candidate matching runner MR2, and when the reference running environment information of the specific runner SR is commensurate with the running environment of the second candidate matching runner MR2, the runner matching unit 300 may recommend the second candidate matching runner MR as the final candidate matching runner.

Accordingly, as shown in FIG. 17, the matching runner information receiving unit 400 may provide the specific runner SR with information that is finally matched with the second candidate matching runner MR2 which is the final candidate matching runner.

More specifically, the matching runner information receiving unit 400 may provide the specific runner SR with the finally matched information through a “matching runner selection” screen 410 shown in FIG. 17. Accordingly, the matching runner information receiving unit 400 may receive, from the specific runner SR, information about the final matching runner MR selected by the specific runner SR as a running competitor from among the final candidate matching runners recommended by the runner matching unit 300.

On the other hand, the runner matching unit 300 may provide the candidate matching runner commensurate with at least one of the running record of the specific runner SR provided from the record management unit 100 and the reference running environment information provided from the running environment collection unit 200.

That is, according to an embodiment of the present invention, the runner matching unit 300 may provide the candidate matching runner in consideration of at least one of the running record and the reference running environment information of the specific runner SR or may provide the candidate matching runner in consideration of both the running record and the reference running environment information of the specific runner SR.

When the matching runner information receiving unit 400 receives the information about the matching runner (for example, MR2, hereinafter MR2 is determined as the final matching runner) selected by the specific runner SR to compete with the running, the running broadcasting unit 500 may broadcast the running situation between the specific runner SR and the matching runner MR2 in real time. In this case, as described above, the specific runner SR may perform the running competition against one of the past time point and the current time point of the matching runner MR2 selected by the specific runner SR.

Hereinafter, the running situation of the specific runner SR and the matching runner MR2 broadcasted by the running broadcasting unit 500 according to an embodiment of the present invention will be described as an example.

As described above, it is assumed that the specific runner SR performs 1:1 running competition against the past record of the matching runner MR2 commensurate with the running record and the reference running environment information of the specific runner SR on Jun. 21, 2020, in the second course of 12 km.

The embodiment described below is illustrative purposes only and the present invention is not limited thereto.

According to an embodiment of the present invention, the running broadcasting unit 500 can provide a sense of realism as if running in real time even when the specific runner SR performs the running competition against the past running record of the matching runner MR by selecting the past time point of the matching runner MR.

Referring to FIG. 18, the running broadcasting unit 500 may broadcast information on the running competition to be performed at a running preparation time point where the specific runner SR prepares to run. For example, the running broadcasting unit 500 may broadcast the start of the running that “the game starts 10 seconds later! Two runners, a specific runner SR and a matching runner MR2, have started from a start point (SP) with a shot to announce the start (b1)”.

Alternatively, the running broadcasting unit 500 may broadcast the type of running with the comment that “the running event of today is a 12 Km marathon”.

In addition, at the running preparation time where the specific runner SR prepares to run, the running broadcasting unit 500 may receive at least one of information on a weak section of the specific runner SR having a low running record and information on a strong section of the specific runner SR having a high running record to broadcast the information to the specific runner SR.

For example, the running broadcasting unit 500 may analyze a running pattern based on the previous running record of the specific runner SR and may determine that the running record is low at a slope of 9 or more. Therefore, the running broadcasting unit 500 may broadcast that “the specific runner SR has a low running record when the slope is 9 or more. In the today course, the second section has the slope 9. Thus, the specific runner SR needs to pay attention to the second section”.

In addition, the running broadcasting unit 500 may broadcast at least one of information on a weak section of the matching runner MR2 having a low running record and information on a strong section of the matching runner MR2 having a high running record to the specific runner SR.

Accordingly, the specific runner SR may prepare and wait for the running competition to be performed at the time of the preparation to run.

In addition, at the running progress time point where the specific runner SR runs, the running broadcasting unit 500 may broadcast at least one of running environment information, distance information, competition information, time information, and a winning plan.

For example, referring to FIG. 19, the running broadcasting unit 500 may broadcast the running environment information that “at present, temperature is 23° C., humidity is 59%, air quality is 17 μg/m², slope is 5%, and wind is weak and good to run (b2)”.

In addition, referring to FIG. 20, the running broadcasting unit 500 may broadcast the distance information that “the specific runner SR, currently passing 2 km section and 2 km remains to complete the first section and 10 km remains to complete the entire sections (b3)”.

Further, referring to FIG. 21, the running broadcasting unit 500 may broadcast the distance information that “the matching runner MR2, currently passing 3 km section and 1 km remains to complete the first section and 9 km remains to complete the entire section (b4)”.

In addition, referring to FIG. 22, the running broadcasting unit 500 may broadcast the competition information that “in the first section, the matching runner MR2 is ahead of the specific runner SR. The heart rate of the specific runner SR is 10% slower than the matching runner MR2 (b5)”.

Further, referring to FIG. 23, the running broadcasting unit 500 may broadcast the competition information that “the specific runner SR entering the second section is overtaking the matching runner MR2 at a location of 5.5 km. The heart rate of the specific runner SR is 10% faster than the matching runner MR2 (b6)”.

In addition, referring to FIG. 24, the running broadcasting unit 500 may broadcast the competition information that “entering the second section, at 5.5 km in the second section, the specific runner SR and the matching runner MR2, two runners are running side by side (b6′)”.

Further, referring to FIG. 25, the running broadcasting unit 500 may broadcast the time information that “the specific runner SR, currently 53 minutes 12 seconds elapse after departure. This is a new record!, the specific runner SR, at 6.2 km in the second section, 3 minutes ahead of his best record. His best record is being renewed!! (b7)”.

In addition, referring to FIG. 26, the running broadcasting unit 500 may broadcast the winning plan that “after completion of the second section, the matching runner MR2 is running faster than the specific runner SR. the specific runner SR, if he doesn't want to be overtaken, he has to run faster than now (b8)”.

Further, referring to FIG. 27, the running broadcasting unit 500 may broadcast the winning plan that “the specific runner SR and the matching runner MR2 tend to slow down in the second half. So, if the specific runner SR keeps speed now, or increases the speed, he can beat the matching runner MR2. Victory is in front of him, cheer up a bit more! (b9)”.

In addition, the running broadcasting unit 500 may broadcast at least one of running rank information and new running record information of the specific runner SR at the end of the running where the specific runner SR finishes the running.

For example, referring to FIG. 28, the running broadcasting unit 500 may broadcast at least one of the running rank information and new running record information of the specific runner SR that “the specific runner SR is ranked first grade! Congratulations! New record is created in this game! (b10)”.

When the running competition between the specific runner SR and the matching runner MR2 ends, the record management unit 100 may manage the running record of the specific runner SR.

In detail, referring to FIG. 29, the record management unit 100 may manage the records for each running section and the total running section of the specific runner SR.

That is, the record management unit 100 may record the first to third sections and the total section in which the specific runner SR runs, and provide the record to the specific runner SR through a “specific runner's section-specified record” screen 110.

Accordingly, the specific runner SR may check the running record of the specific runner SR through the “specific runner's section-specified record” screen 110.

Alternatively, the record management unit 100 may provide selection buttons, for example, at least one of the section-specific record confirmation button 121 and the highlight button 123 to allow the specific runner SR to confirm the detail of the running record by touching the “specific runner's section-specified record” screen 110.

That is, the record management unit 100 may provide the specific runner SR with information or detailed information on the running record of the specific runner SR.

In addition, the record management unit 100 may manage a section, in which a leading runner is changed between the specific runner SR and the matching runner MR2, as a highlight section.

In detail, as shown in FIG. 29, the highlight button 123 may be provided to the specific runner SR through the “specific runner's section-specified record” screen 110.

When the specific runner SR touches the highlight button 123, as shown in FIG. 30, the record management unit 100 may provide a “highlight section” screen 112 to the specific runner SR.

Accordingly, the specific runner SR may acquire information on the highlight section where the leading runner is changed because the second matching runner MR2 is overtaken by the specific runner SR by touching play buttons 125 and 127 on the “highlight section” screen 112.

More specifically, when the specific runner SR touches the play buttons 125 and 127 to check the highlight section, the record management unit 100 may provide contents of the broadcasting in the highlight section executed by the running broadcasting unit 500.

For example, when the specific runner SR wants to check the broadcasting for an overtaking point OP described above with reference to FIG. 25, the specific runner SR may touch the play button 125 for the overtaking point OP and the record management unit 100 may provide the specific runner SR with the broadcasting contents for the overtaking point. The contents may be understood as a general concept including audio, map display, and video. In addition, the provision of the broadcasting contents may be understood as a general concept that includes the downloading of all or a part of the contents, and real time streaming.

Further, the record management unit 100 may provide information on sections in which important events occur during the running competition in addition to a section in which the leading runner is changed between the specific runner SR and the matching runner MR2. In detail, the record management unit 100 may provide the highlight button 123 to the specific runner SR.

When the specific runner SR touches the highlight button 123, the record management unit 100 may provide the “highlight section” screen 112 to the specific runner SR.

Accordingly, the specific runner SR may acquire information on the sections in which the important events occur by touching the play buttons 125 and 127 formed on the “highlight section” screen 112. Specifically, for example, the specific runner SR may acquire information about entry information in the beginning, middle and second half of the race, the situation 100m before the finish point, the situation of the speed-up section, the running competition turned over and over, the difference in distance and speed from the opponent, the new record, and the like by touching the play buttons 125 and 127. In addition, the specific runner SR may also receive the overall contents related to the running situation.

The audio system 1000 for broadcasting running according to the embodiment of the present invention has been described above.

The audio system 1000 for broadcasting running may include a record management unit 100 configured to manage running records of a specific runner SR, a running environment collection unit 200 configured to acquire reference running environment information related to a running environment including at least one of a weather, a temperature, a humidity, an air quality, and a slope on a running path of the specific runner SR, a runner matching unit 300 configured to recommend candidate matching runners belonging to the other space different from a space of the specific runner SR and having running records commensurate with the running record of the specific runner SR, a matching runner information receiving unit 400 for receiving information about a matching runner selected by the specific runner SR as a running competitor of the specific runner from among the candidate matching runners recommended by the runner matching unit 300, and a running broadcasting unit 500 for broadcasting a running situation of the specific runner in real time in comparison with one selected from a past time point and a current time point of the matching runner.

In addition, as shown in FIG. 31, a method of broadcasting running by using the audio system 1000 for broadcasting running may include receiving a request from a specific runner SR to select a candidate matching runner to compete with the specific runner (S110), acquiring a running record of the specific runner SR and reference running environment information related to a running environment including at least one of a weather, a temperature, a humidity, an air quality, and a slope on a running path of the specific runner SR (S120), providing candidate matching runners belonging to the other space different from a space of the specific runner and matching at least one of the running record of the specific runner SR and the reference running environment information (S130), receiving, from the specific runner SR, information about a matching runner selected by the specific runner SR from among the recommended candidate matching runners to compete in running (S140), broadcasting a running situation of the specific runner SR in real time in comparison with one selected from a past time point and a current time point of the matching runner (S150), and managing a running record of the specific runner SR.

According to an embodiment of the present invention, as described above, the running record of the specific runner managed in step S150 may be provided to step S120. Accordingly, the previous running record of the specific runner may be taken into account after step S120.

In addition, as described above, when the specific runner SR selects a past time point of the matching runner MR, the specific runner SR may compete with the past running record of the matching runner MR. When the specific runner SR selects the current time point of the matching runner MR, the specific runner SR may perform the running competition with an real image of the matching runner MR.

Although the preferred embodiments of the present invention have been described in detail until now, the scope of the present invention is not limited to the embodiments and should be construed by the attached claims. Further, it should be understood that those skilled in the art to which the present invention pertains may variously correct and modify the present invention without departing from the scope of the present invention.

What is claimed is:

1. An audio system for broadcasting running, the audio system comprising:
a record management unit configured to manage running records of a specific runner;
a runner matching unit configured to recommend candidate matching runners belonging to the other space different from a space of the specific runner and having running records commensurate with the running record of the specific runner;
a matching runner information receiving unit for receiving information about a matching runner selected by the specific runner as a running competitor of the specific runner from among the candidate matching runners recommended by the runner matching unit; and
a running broadcasting unit for broadcasting a running situation of the specific runner in real time in comparison with one selected from a past time point and a current time point of the matching runner.

2. The audio system of claim 1, wherein the runner matching unit recommends a candidate matching runner having a running record commensurate with the running record of the specific runner by taking a past running record of the candidate matching runner into consideration.

3. The audio system of claim 2, wherein the running broadcasting unit broadcasts at least one of distance information, competition information, time information, and a winning plan during a running progress point at which the specific runner proceeds to run,
wherein the distance information includes at least one of a running distance run by the specific runner, a remaining distance to be run by the specific runner, a running distance run by the matching runner, a remaining distance to be run by the matching runner, and a difference in the running distance between the specific runner and the matching runner,
wherein the competition information includes at least one of a moment when a leading runner is changed between the specific runner and the matching runner, and a moment when the specific runner and the matching runner run side by side,
wherein the time information includes at least one of a time elapsed after the specific runner starts running, and a running progress time in comparison with a time record for each running section of the specific runner, and
wherein the winning plan includes at least one of a speed difference between the specific runner and the matching runner, a pattern analysis on a running speed of the specific runner, and an advice based on the pattern analysis of the specific runner.

4. The audio system of claim 2, wherein the running broadcasting unit broadcasts at least one of ranking information and new running record information of the specific runner at an end point of running at which the specific runner ends running.

5. The audio system of claim 2, further comprising a running environment collection unit configured to acquire reference running environment information related to a running environment including at least one of a weather, a temperature, a humidity, an air quality, and a slope on a running path of the specific runner,
wherein the runner matching unit recommends a candidate matching runner belonging to the other space different from a space of the specific runner and having running environment information commensurate with the reference running environment information of the specific runner.

6. The audio system of claim 1, wherein, at a running preparation point where the specific runner prepares to run,
the running broadcasting unit receives at least one of information about a weak section of the specific runner where the specific runner has a weak running record and information about a strong section of the specific runner where the specific runner has a high running record from the record management unit and broadcasts the information to the specific runner, and
the running broadcasting unit broadcasts at least one of information about a weak section of the matching runner where the matching runner has a weak running record and information about a strong section of the matching runner where the matching runner has a high running record to the specific runner.

7. A method of audio-broadcasting running, the method comprising:
receiving a request from a specific runner to select a candidate matching runner to compete with the specific runner;
acquiring a running record of the specific runner and reference running environment information related to a running environment including at least one of a weather, a temperature, a humidity, an air quality, and a slope on a running path of the specific runner;
providing candidate matching runners belonging to the other space different from a space of the specific runner and matching at least one of the running record of the specific runner and the reference running environment information;
receiving, from the specific runner, information about a matching runner selected by the specific runner from among the recommended candidate matching runners to compete in running; and
broadcasting a running situation of the specific runner in real time in comparison with one selected from a past time point and a current time point of the matching runner,
wherein, when the specific runner selects the past time point of the matching runner, the specific runner performs a competitive run with respect to a past run record of the matching runner, and
when the specific runner selects the current time point of the matching runner, the specific runner performs a competitive run with a real image of the matching runner.
